(19) United States
(12) Patent Application Publication
(10) Pub. No.: US 2016/0248149 A1
(43) Pub. Date: Aug. 25, 2016

(54) THREE DIMENSIONAL (3D) ANTENNA STRUCTURE

(71) Applicant: QUALCOMM Incorporated, San Diego, CA (US)

(72) Inventors: Daeik Daniel Kim, Del Mar, CA (US); David Francis Berdy, San Diego, CA (US); Mario Francisco Velez, San Diego, CA (US); Chengjie Zuo, Santee, CA (US); Changhan Hobie Yun, San Diego, CA (US); Jonghae Kim, San Diego, CA (US)

(21) Appl. No.: 14/627,863

(22) Filed: Feb. 20, 2015

(51) Int. Cl. H01Q 1/36; H01Q 7/00

(52) U.S. Cl. CPC H01Q 1/36; H01Q 7/00

(57) ABSTRACT

An apparatus includes a substrate package and a three dimensional (3D) antenna structure formed in the substrate package. The 3D antenna structure includes multiple substructures to enable the 3D antenna structure to operate as a beam-forming antenna. Each of the multiple substructures has a slanted-plate configuration or a slanted-loop configuration.

### I. FIELD

The present disclosure is generally related to a three dimensional (3D) antenna structure.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Wireless devices may include antenna arrays, such as two dimensional (2D) planar antenna arrays. The 2D planar antenna arrays may be used to generate a radiation pattern that is used to transmit millimeter (mm)-wave signals. The 2D planar antenna arrays have a limited amount of beam-forming directionality within a range, such as less than 30° (e.g., less than)±30°. Accordingly, the 2D planar antenna arrays provide a limited angle of coverage for mm-wave communication.

### III. SUMMARY

The present disclosure describes a three dimensional (3D) antenna structure formed in a substrate package (e.g., a coreless substrate, such as a multi-layered substrate package). The 3D antenna structure may include multiple substructures configured to operate as a beam-forming antenna. Each of the multiple substructures may extend across multiple layers of the substrate package and may have a slanted-plate configuration (resembling a staircase) or a slanted-loop configuration. In some implementations, the 3D antenna structure may be included in an antenna array that includes multiple 3D antenna array structures. Each of the 3D antenna structures may be operated independently of other 3D antenna structures to enable beam-forming directionality within a range greater than 30 degrees (e.g., greater than)±30°, such as up to or greater than ±45°.

In a particular aspect, an apparatus includes a substrate package and a three dimensional (3D) antenna structure formed in the substrate package. The 3D antenna structure includes multiple substructures to enable the 3D antenna structure to operate as a beam-forming antenna. At least one of the multiple substructures has a slanted-plate configuration or a slanted-loop configuration.

In another particular aspect, a method of forming an antenna includes forming a first substructure of a three dimensional (3D) antenna structure in a substrate package. The first substructure has a configuration of a slanted-plate configuration or a slanted-loop configuration. The method further includes forming a second substructure of the 3D antenna structure in the substrate package. The second substructure may have the same configuration as the first substructure. The first substructure and the second substructure enable the 3D antenna structure to operate as a beam-forming antenna.

In another particular aspect, an apparatus includes a substrate package and a three dimensional (3D) antenna structure formed in the substrate package, the 3D antenna structure including a substructure. The substructure includes a first metal layer formed on a first layer of the substrate package. The substructure further includes a second metal layer formed on a second layer of the substrate package and a first via that couples the first metal layer to the second metal layer. The substructure further includes a third metal layer formed on the second layer of the substrate package and a second via that couples the first metal layer to the third metal layer. The substructure further includes a fourth metal layer formed on a third layer of the substrate package. The first metal layer is coupled to the fourth metal layer via a first path that includes the second metal layer and the first via. The first metal layer is also coupled to the fourth metal layer via a second path that includes the third metal layer and the second via.

In another particular aspect, a method of forming a three dimensional (3D) antenna structure includes forming a first metal layer on a first layer of the substrate package and forming a first via structure and a second via structure coupled to the first metal layer. The method also includes forming a second metal layer and a third metal layer on a second layer of the substrate package. The second metal layer is coupled to the first via structure, and the third metal layer is coupled to the second via structure. The method includes forming a fourth metal layer on a third layer of the substrate package. The first metal layer is coupled to the fourth metal layer via a first path that includes the second metal layer and the first via, and the first metal layer is coupled to the fourth metal layer via a second path that includes the third metal layer and the second via.

One particular advantage provided is a 3D antenna structure that enables an amount of beam-forming directionality within a range greater than 30°, such as up to or greater than 45°. Accordingly, the 3D antenna structure may enable a larger angle of coverage for mm-wave communication than conventional 2D planar antenna arrays.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of system that includes a three dimensional (3D) antenna structure having multiple substructures;

FIG. 2 illustrates examples of a 3D antenna structure including substructures having a slanted-plate configuration;

FIG. 3 illustrates examples of a 3D antenna structure including substructures having a slanted-loop configuration

FIG. 4 illustrates examples of radiation patterns produced by the 3D antenna structure of FIG. 1;

FIG. 5 is a flow chart of a particular illustrative embodiment of a method of forming the 3D antenna structure of FIG. 1;

FIG. 6 is a flow chart of a particular illustrative embodiment of a method of forming a 3D antenna structure that includes a substructure having a slanted-loop configuration; and

FIG. 7 is a block diagram of wireless device including a beam-forming antenna; and

FIG. 8 is a data flow diagram of a particular illustrative embodiment of a manufacturing process to manufacture electronic devices that include a beam-forming antenna.

### V. DETAILED DESCRIPTION

Particular embodiments of the present disclosure are described below with reference to the drawings. In the description, common features are designated by common reference numbers.

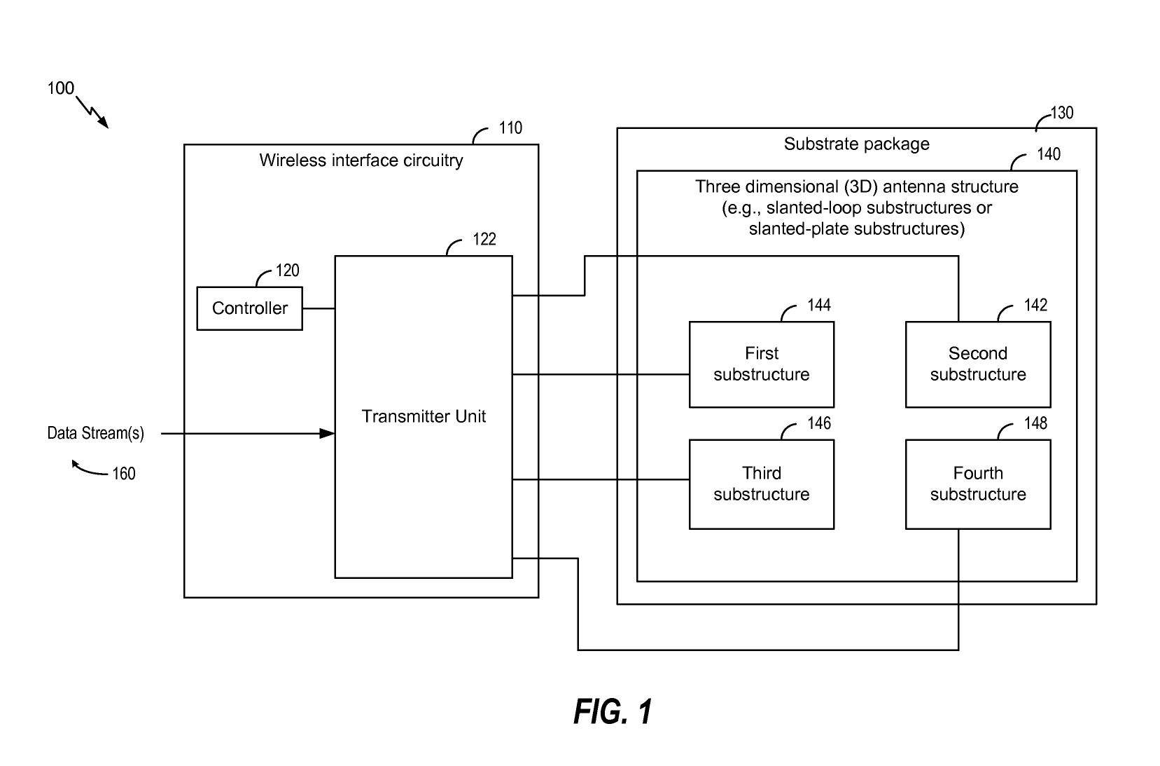

Referring to FIG. 1, a particular illustrative embodiment of a system 100 that includes a three dimensional (3D) antenna structure having multiple substructures is shown. The system 100 may include wireless interface circuitry 110 and a substrate package 130. Although the wireless interface circuitry 110 is illustrated as being separate from the substrate package 130, in other implementations, one or more components of the wireless interface circuitry may be included on or within the substrate package 130.

The substrate package 130 may include a coreless substrate, or core laminate substrate, such as a multi-layered substrate package. The substrate package 130 may include one or more 3D antenna structures, such as a 3D antenna structure 140, formed in the substrate package 130. For example, in some implementations, the substrate package 130 may include an array of 3D antenna structures (e.g., multiple 3D antenna structures).

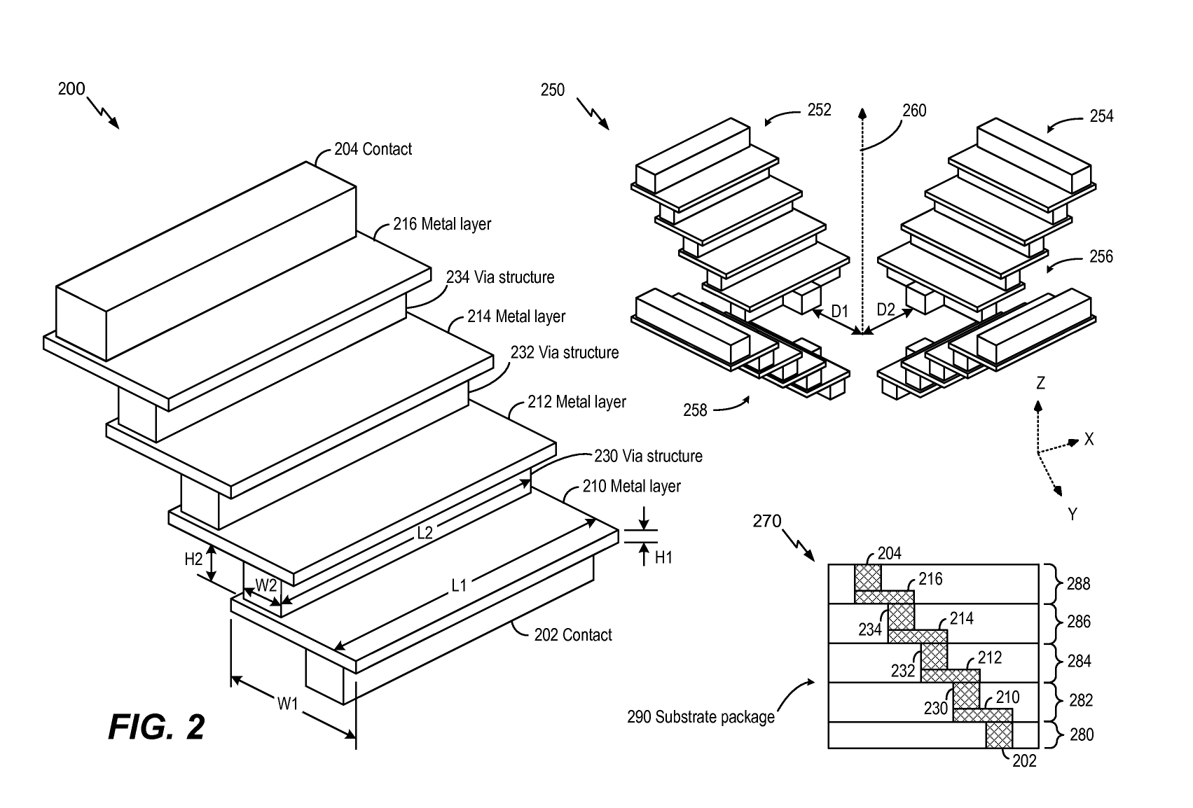

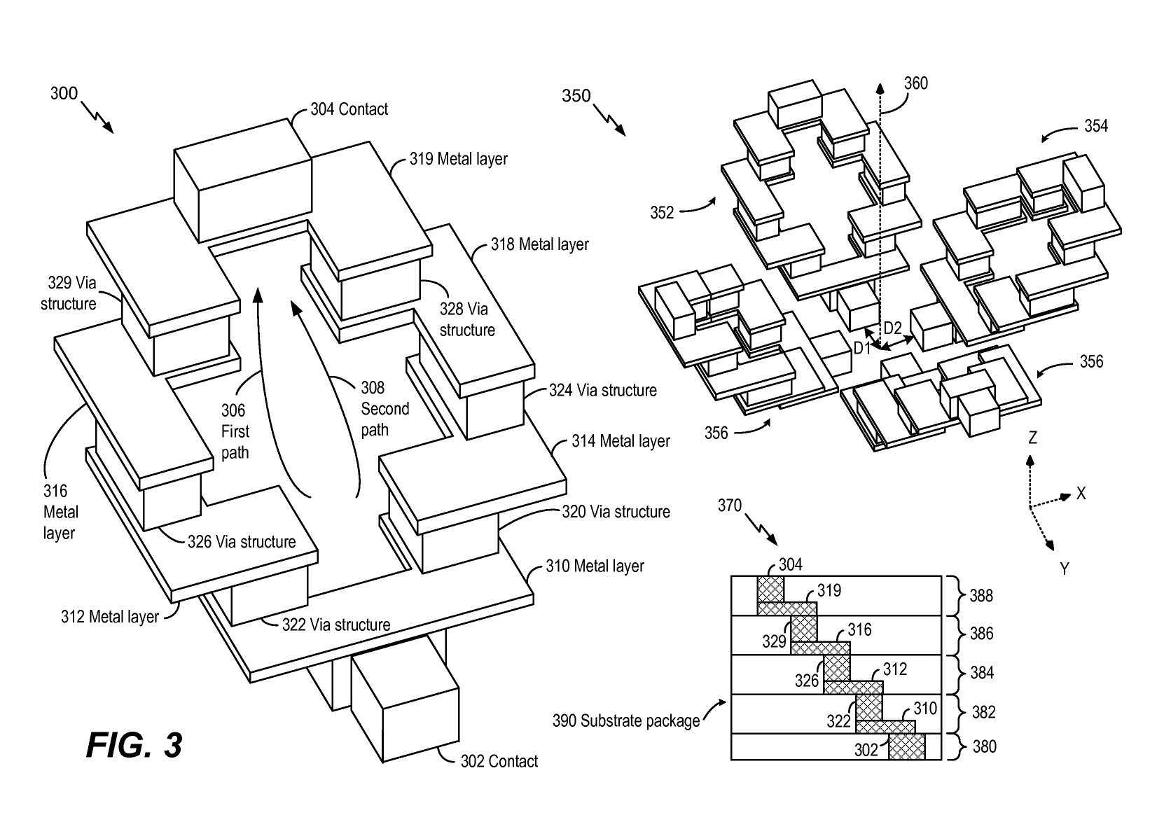

The 3D antenna structure 140 may be configured to transmit and/or receive wireless signals, such as radio frequency (RF) signals (e.g., millimeter (mm)-wave signals). For example, the 3D antenna structure 140 may be configured to operate within one or more frequency ranges, such as a range of 40 gigahertz (GHz) to 100 GHz. The 3D antenna structure 140 may include one or more substructures configured to operate as a beam-forming antenna. For example, the 3D antenna structure 140 may include a first substructure 144, a second substructure 142, a third substructure 146, and a fourth substructure 148. When the 3D antenna structure 140 includes multiple substructures, the multiple substructures may include two or more distinct (e.g., separate) substructures. Although the 3D antenna structure 140 is illustrated as including four substructures, in other implementations, the 3D antenna structure 140 may include more than or fewer than four substructures. At least one of the one or more substructures may have a slanted-plate configuration, as described with reference to FIG. 2, or may have a slanted-loop configuration, as described with reference to FIG. 3. Each substructure of the 3D antenna structure may be operated independently of other substructures of the 3D antenna structure, as described further herein. In some implementations, an antenna array may include multiple substructures and/or multiple 3D antenna structures. The more substructures and/or the more 3D antenna structures that are included in the antenna array, the better the directionality control and sensitivity of the array.

The wireless interface circuitry 110 may be coupled to the substrate package 130 (e.g., coupled to the 3D antenna structure 140) and may be configured to generate signals to be transmitted by the 3D antenna structure 140 and/or to process signals received from the 3D antenna structure 140. As illustrated in FIG. 1, the wireless interface circuitry 110 is configured to generate signals to be transmitted by the 3D antenna structure 140 and includes a controller 120 and a transmitter unit 122, as illustrative, non-limiting examples.

The transmitter unit 122 may receive one or more streams 160 (e.g., one or more baseband signals) and generate an RF output signal for each substructure of the 3D antenna structure 140. The transmitter unit 122 may include one more mixers, one or more splitters, one or more filters, one or more amplifiers (e.g., one or more power amplifiers and/or one or more driver amplifiers), one or more phase shifters, or a combination thereof, as illustrative, non-limiting examples. To illustrate, as a particular illustrative example, the transmitter unit 122 may include a mixer that is configured to receive the one or more streams 160 and to provide an output signal to a splitter. The splitter may split the received signal into multiple signals and each of the multiple signals may be provided to an amplifier and/or a phase shifter that corresponds to a particular substructure of the 3D antenna structure 140. Each substructure of the 3D antenna structure may receive an RF output signal from its corresponding amplifier and/or corresponding phase shifter. As another illustrative example, the transmitter unit 122 may include a mixer for each substructure of the 3D antenna structure 140. Each mixer may receive the one or more streams 160 and provide an output signal to a corresponding amplifier and/or a corresponding phase shifter. Each substructure of the 3D antenna structure may receive an RF output signal from its corresponding amplifier and/or corresponding phase shifter.

The controller 120 may be configured to provide one or more control signals to the transmitter unit 122. The one or more control signals may cause the transmitter unit 122 to adjust a magnitude and/or to adjust a phase associated with one or more RF output signals provided to the 3D antenna structure 140. For example, the controller 120 may provide a first set of one or more control signals to one or more amplifiers included in the transmitter unit 122, a second set of one or more control signals to one or more phase shifters included in the transmitter unit 122, or a combination thereof, as illustrative, non-limiting examples. Accordingly, a first RF output signal provided to the first substructure 144 from the transmitter unit 122 may have a first magnitude and/or a first phase that is different than a second magnitude and/or a second phase of a second RF output signal provided to the second substructure 142 from the transmitter unit 122. Thus, each substructure of the 3D antenna structure 140 may receive and transmit the same RF signal except that the magnitude and phase of each RF signal may be adjusted such that a focused beam (e.g., radiated radio wave) is transmitted from the 3D antenna structure 140. Although the controller 120 is illustrated as being included in the wireless interface circuitry 110, in other implementations, the controller 120 may not be part of the wireless interface circuitry 110. For example, the controller 120 may be included in a processor, such as a processor (not shown) configured to generate the one or more streams 160.

During operation, a processor (not shown) may process data to generate the one or more streams 160 of data, such as one or more baseband signals. For example, the processor may be included in a device that includes the system 100. The processor, such as a digital signal processor (DSP), may process the data by performing one or more operations on the data, such as encoding, interleaving, symbol mapping, etc., as illustrative, non-limiting examples. The one or more streams 160 may be received at the wireless interface circuitry 110 to be conditioned to generate one or more RF output signals for the 3D antenna structure 140 to transmit. For example, the transmitter unit 122 may receive the one or more streams 160 and one or more control signals from the controller 120 and may generate the one or more RF output signals. To illustrate, the transmitter unit 122 may generate a first RF output signal that is provided to the first substructure 144, a second RF output signal that is provided to the second substructure 142, a third RF output signal that is provided to the third substructure 146, and a fourth RF output signal that is provided to the fourth substructure 148. Accordingly, the wireless interface circuitry 110 is configured to independently control signals provided to each substructure of the 3D antenna structure 140.

Each of the one or more RF output signals may be transmitted by the 3D antenna structure 140, such that the 3D antenna structure 140 produces a radiated radio wave, such as a millimeter (mm) wave signal. For example, the 3D antenna structure 140 may have a beam-forming directionality in a range that is greater than 30°, such as up to or greater than 45°.

By providing the one or more RF output signals to the 3D antenna structure 140, a focused beam (e.g., a radiated radio wave) may be emitted from the 3D antenna structure 140. For example, the 3D antenna structure 140 including at least one substructure having the slanted-plate configuration or the slanted-loop configuration may enable beam-forming directionality in a range that is greater than 30°. Accordingly, the 3D antenna structure 140 may have a larger angle of coverage for mm-wave communication than conventional 2D planar antenna arrays.

Referring to FIG. 2, examples of a 3D antenna structure including substructures having a slanted-plate configuration are depicted. The slanted-plate configuration may resemble a staircase. An example of a substructure having the slanted-plate configuration is depicted and generally designated 200. The substructure 200 may be included in the 3D antenna structure 140 of FIG. 1. The substructure 200 may be formed in a substrate package, such as the substrate package 130 of FIG. 1.

The substructure 200 may include contacts 202, 204. The contacts 202, 204 may be configured to couple the substructure 200 to wireless interface circuitry, such as the wireless interface circuitry 110 (e.g., the transmitter unit 122) of FIG. 1. For example, the contact 202 may be configured to couple the substructure 200 to the wireless interface circuitry and the contact 204 may be configured to couple the substructure 200 to ground. As another example, the contact 204 may be configured to couple the substructure 200 to the wireless interface circuitry and the contact 202 may be configured to couple the substructure 200 to ground.

The substructure 200 may include multiple metal layers and multiple via structures coupled between the contacts 202, 204. The multiple metal layers may include a first metal layer 210, a second metal layer 212, a third metal layer 214, and a fourth metal layer 216. Although the substructure 200 is illustrated as including four metal layers, in other implementations, the substructure 200 may include more than or fewer than four metal layers. The multiple via structures may include a first via structure 230, a second via structure 232, and a third via structure 234. Although the substructure 200 is illustrated as including three via structures, in other implementations, the substructure 200 may include more than or fewer than three via structures.

The first metal layer 210 may be coupled to the contact 202 and the fourth metal layer 216 may be coupled to the contact 204. The first metal layer 210 may be formed above the contact 202. The first metal layer 210 may have a first overall height (H1). A top surface (and/or a bottom surface) of the first metal layer 210 may have a first overall length (L1) and a first overall width (W1). In some implementations, a shape of the top surface (and/or the bottom surface) of the first metal layer 210 may be rectangular or substantially rectangular. In other implementations, the shape of the top surface of the first metal layer 210 may be a shape other than rectangular.

The first via structure 230 may be formed above the first metal layer 210. The first via structure 230 may have an overall height (H2), an overall length (L2), and an overall width (W2). The overall length (L2) of the first via structure 230 may be equal to the first overall length (L1) of the first metal layer 210. In some implementations, the overall length (L2) may be within a range of one half of the first overall length (L1) to the first overall length (L2). In other implementations, the overall length (L2) may be greater than the first overall length (L1).

The second metal layer 212 may be formed above the first via structure 230. The second metal layer 212 may be offset relative to the first metal layer 210. The second metal layer 212 may be coupled to the first metal layer 210 by the first via structure 230. The second via structure 232 may be formed above the second metal layer 212. The second via structure 232 may be offset relative to the first via structure 230. The third metal layer 214 may be formed above the second via structure 232. The third metal layer 214 may be offset relative to the second metal layer 212. The third metal layer 214 may be coupled to the second metal layer 212 by the second via structure 232. The third via structure 234 may be formed above the third metal layer 214. The third via structure 234 may be offset relative to the second via structure 232. The fourth metal layer 216 may be formed above the third via structure 234. The fourth metal layer 216 may be offset relative to the third metal layer 214. The fourth metal layer 216 may be coupled to the third metal layer 214 by the third via structure 234. The contact 204 may be formed above the fourth metal layer 216.

In some implementations, each of the metal layers 210-214 may have a corresponding top surface that is the same shape. In other implementations, at least one metal layer of the metal layers 210-214 may have a shape of a top surface that is different than a shape of one or more other metal layers of the metal layers 210-214.

In other implementations, each metal layer of the substructure 200 may have a top surface (and/or a bottom surface) that is a shape other than a rectangle, such as a trapezoid. When the top surface is shaped as a trapezoid, each metal layer may have the same overall width (W1), but an overall length of each metal layer may be different. For example, the first overall length (L1) of the first metal layer 210 may be smaller than a second overall length of the second metal layer 212, and the second overall length of the second metal layer 212 may be smaller than a third overall length of the third metal layer 214. A first edge of the trapezoid of the first metal layer 210 may be positioned proximate to the contact 202 and a second edge of the trapezoid of the first metal layer 210 may be positioned proximate to the first via structure 230. The first edge and the second edge of the first metal layer 210 may be parallel, and the first edge may have a shorter length than the second edge. A third edge of the trapezoid of the second metal layer 212 may be positioned proximate to the first via structure 230 and a fourth edge of the trapezoid of the second metal layer 212 may be positioned proximate to the second via structure 232. The third edge and the fourth edge of the second metal layer 212 may be parallel, and the third edge may have a shorter length than the fourth edge.

An example of the substructure 200 formed within a substrate package 290 is depicted at 270. The substrate package 290 may include or correspond to the substrate package 130 of FIG. 1. The substrate package 290 may include multiple layers, such as a first layer 280, a second layer 282, a third layer 284, a fourth layer 286, and a fifth layer 288. Although the substrate package 290 is illustrated as including five layers, in other implementations, the substrate package 290 may include more than five or fewer than five layers.

The first layer 280 may include the contact 202. The first metal layer 210 may be positioned above (e.g., formed on) the first layer 280 of the substrate package 290. The second metal layer 212 may be positioned above (e.g., formed on) the second layer 282 of the substrate package 290. The second metal layer 212 may be offset relative to the first metal layer 210. The first via structure 230 may be included in the second layer 282 and may be configured to couple the first metal layer 210 to the second metal layer 212. The third metal layer 214 may be positioned above (e.g., formed on) the third layer 284 of the substrate package 290. The third metal layer 214 may be offset relative to the second metal layer 212. The second via structure 232 may be included in the third layer 284 and may be configured to couple the second metal layer 212 to the third metal layer 214.

The fourth metal layer 216 may be positioned above (e.g., formed on) the fourth layer 286 of the substrate package 290. The fourth metal layer 216 may be offset relative to the third metal layer 214. The third via structure 234 may be included in the fourth layer 286 and may be configured to couple the third metal layer 214 to the fourth metal layer 216. The fifth layer 288 of the substrate package 290 may include the contact 204. The contact 204 may be positioned above (e.g., formed on) the fourth metal layer 216.

An example of a 3D antenna structure that includes multiple substructures is depicted and generally designated 250. For example, the 3D antenna structure 250 may include or correspond to the 3D antenna structure 140 of FIG. 1. The 3D antenna structure 250 may be included within a substrate package, such as the substrate package 130 of FIG. 1 or the substrate package 290 of FIG. 2. The 3D antenna structure 250 may include multiple substructures, such as a first substructure 252, a second substructure 254, a third substructure 256, and a fourth substructure 258. The first substructure 252, the second substructure 254, the third substructure 256, and the fourth substructure 258 may include or correspond to the first substructure 144, the second substructure 142, the third substructure 146, and the fourth substructure 148 of FIG. 1, respectively. Although the 3D antenna structure 250 is illustrated as including four substructures, in other implementations, the 3D antenna structure 250 may include more than or fewer than four substructures. In some implementations, an antenna array may include multiple substructures and/or multiple 3D antenna structures. The more substructures and/or the more 3D antenna structures that are included in the antenna array, the better the directionality control and sensitivity of the array.

One or more of the substructures 252-258 may have the slanted-plate configuration. For example, one or more of the substructures 252-258 may include or correspond to the substructure 200. In some implementations, each of the substructures 252-258 has the slanted-plate configuration. In other implementations, at least one of the substructures 252-258 has the slanted-plate configuration and one or more of the other substructures may have another configuration, such as a slanted-loop configuration as described with reference to FIG. 3.

Each of the substructures 252-258 may be positioned about an axis 260 of the antenna structure 250. Each substructure may be positioned relative to the axis 260. For example, a first feature of the first substructure 252 may be positioned a first distance (D1) from the axis 260, and a second feature (corresponding to the first feature) of the second substructure 254 may be positioned a second distance (D2) from the axis 260. To illustrate, a first contact of the first substructure 252 may be positioned the first distance (D1) from the axis 260 and a second contact of the second substructure 254 may be positioned the second distance (D2) from the axis 260. In some implementations, each of substructures 252-258 may be positioned the same distance from the axis 260. For example, the first distance (D1) may be equal to the second distance (D2). In other implementations, one or more the substructures 252-258 may not be positioned at the same distance as the other substructures 252-258. For example, the first distance (D1) of the first substructure 252 may be different than the second distance (D2), and each of the second substructure 254, the third substructure 256, and the fourth substructure 258 may be the second distance (D2) from the axis 260.

A 3D antenna structure, such as the 3D antenna structure 250, that includes at least one substructure having the slanted-plate configuration (e.g., the substructure 200), may have beam-forming directionality within a range that is greater than 30°. Accordingly, the 3D antenna structure 250 may have a larger angle of coverage for mm-wave communication than conventional 2D planar antenna arrays which have a limited amount of beam-forming directionally (e.g., less than 30°).

Referring to FIG. 3, examples of a 3D antenna structure including substructures having a slanted-loop configuration are depicted. An example of a substructure having the slanted-loop configuration is depicted and generally designated 300. The substructure 300 may be included in the 3D antenna structure 140 of FIG. 1 or the 3D antenna structure 250 of FIG. 2. The substructure 300 may be formed in a substrate package, such as the substrate package 130 of FIG. 1 or the substrate package 290 of FIG. 2.

The substructure 300 may include contacts 302, 304. The contacts 302, 304 may be configured to couple the substructure 300 to wireless interface circuitry, such as the wireless interface circuitry 110 (e.g., the transmitter unit 122) of FIG. 1. For example, the contact 302 may be configured to couple the substructure 300 to the wireless interface circuitry and the contact 304 may be configured to couple the substructure 300 to ground. As another example, the contact 304 may be configured to couple the substructure 300 to the wireless interface circuitry and the contact 302 may be configured to couple the substructure 300 to ground.

The substructure 300 may include multiple metal layers and multiple via structures coupled between the contacts 202, 204. The multiple metal layers may include a first metal layer 310, a second metal layer 312, a third metal layer 314, a fourth metal layer 316, a fifth metal layer 318, and a sixth metal layer 319. Although the substructure 300 is illustrated as including six metal layers, in other implementations, the substructure 300 may include more than or fewer than six metal layers. The multiple via structures may include a first via structure 320, a second via structure 322, a third via structure 324, a fourth via structure 326, a fifth via structure 328, and a sixth via structure 329. Although the substructure 300 is illustrated as including six via structures, in other implementations, the substructure 300 may include more than or fewer than six via structures.

The first metal layer 310 may be coupled to the contact 302 and the sixth metal layer 319 may be coupled to the contact 304. The first metal layer 310 and/or the sixth metal layer 319 may have a U-shape. In other implementations, the first metal layer 310 and/or the sixth metal layer 319 may have a shape other than the U-shape. The first via structure 320 and the second via structure 322 may be formed above the first metal layer 310. The first via structure 320 may be distinct (e.g., separate) from the second via structure 322.

The third metal layer 314 may be formed above the first via structure 320, and the second metal layer 312 may be formed above the second via structure 322. The second metal layer 312 and/or the third metal layer 314 may have an L-shape. In other implementations, the second metal layer 312 and/or the third metal layer 314 may have a shape other than the L-shape. Each of the second metal layer 312 and the third metal layer 314 may be offset relative to the first metal layer 310. The second metal layer 312 may be coupled to the first metal layer 310 by the second via structure 322, and the third metal layer 314 may be coupled to the first metal layer 310 by the first via structure 320.

The third via structure 324 may be formed above the third metal layer 314, and the fourth via structure 326 may be formed above the second metal layer 312. The third via structure 324 may be offset relative to the first via structure 320, and the fourth via structure 326 may be offset relative to the second via structure 322. The fifth metal layer 318 may be formed above the third via structure 324, and the fourth metal layer 316 may be formed above the fourth via structure 326. The fourth metal layer 316 may be offset relative to the second metal layer 312, and the fifth metal layer 318 may be offset relative to the third metal layer 314. The fourth metal layer 316 may be coupled to the second metal layer 312 by the fourth via structure 326, and the fifth metal layer 318 may be coupled to the third metal layer 314 by the third via structure 324.

The fifth via structure 328 may be formed above the fifth metal layer 318, and the sixth via structure 329 may be formed above the fourth metal layer 316. The fifth via structure 328 may be offset relative to the third via structure 324, and the sixth via structure 329 may be offset relative to the fourth via structure 326. The sixth metal layer 319 may be formed above the fifth via structure 328 and above the sixth via structure 329. The sixth metal layer 319 may be offset relative to the fourth metal layer 316 and/or the fifth metal layer 318. The sixth metal layer 319 may be coupled to the fourth metal layer 316 by the sixth via structure 329, and the sixth metal layer 319 may be coupled to the fifth metal layer 318 by the fifth via structure 328. The contact 304 may be formed above the sixth metal layer 319.

The first metal layer 310 (e.g., the contact 302) may be coupled to the sixth metal layer 319 (e.g., the contact 304) by a first path 306 and by a second path 308. The first path 306 may be distinct from the second path 308. The first path 306 may include the first metal layer 310 (e.g., the contact 302), the second via structure 322, the second metal layer 312, the fourth via structure 326, the fourth metal layer 316, the sixth via structure 329, and the sixth metal layer 319 (e.g., the contact 304), as an illustrative, non-limiting example. The second path 308 may include the first metal layer 310 (e.g., the contact 302), the first via structure 320, the third metal layer 314, the third via structure 324, the fifth metal layer 318, the fifth via structure 328, and the sixth metal layer 319 (e.g., the contact 304), as an illustrative, non-limiting example. Although, the first path 306 and the second path 308 depicted as indicating a direction from the contact 302 to the contact 304, it is understood that the first path 306 and the second path 308 may each extend from the contact 304 to the contact 302.

An example of the substructure 300 formed within a substrate package 390 is depicted at 370. The substrate package 390 may include or correspond to the substrate package 130 of FIG. 1 or the substrate package 290 of FIG. 2. The substrate package 390 may include multiple layers, such as a first layer 380, a second layer 382, a third layer 384, a fourth layer 386, and a fifth layer 388. Although the substrate package 390 is illustrated as including five layers, in other implementations, the substrate package 390 may include more than five or fewer than five layers.

The first layer 380 may include the contact 302. The first metal layer 310 may be positioned above (e.g., formed on) the first layer 380 of a substrate package 390. The second metal layer 312 may be positioned above (e.g., formed on) the second layer 382 of the substrate package 390. The second metal layer 312 may be offset relative to the first metal layer 310. The second via structure 322 may be included in the second layer 382 and may be configured to couple the first metal layer 310 to the second metal layer 312. Although not depicted, the third metal layer 314 may be positioned above (e.g., formed on) the second layer 382 of the substrate package 390. The third metal layer 314 may be offset relative to the first metal layer 310. Additionally, the first via structure 320 may be included in the second layer 382 and may be configured to couple the first metal layer 310 to the third metal layer 314.

The fourth metal layer 316 may be positioned above (e.g., formed on) the third layer 384 of the substrate package 290. The fourth metal layer 316 may be offset relative to the second metal layer 312. The fourth via structure 326 may be included in the third layer 384 and may be configured to couple the second metal layer 312 to the fourth metal layer 316. Although not depicted, the fifth metal layer 318 may be positioned above (e.g., formed on) the third layer 384 of the substrate package 390. The fifth metal layer 318 may be offset relative to the third metal layer 314. Additionally, the third via structure 324 may be included in the third layer 384 and may be configured to couple the third metal layer 314 to the fifth metal layer 318.

The sixth metal layer 319 may be positioned above (e.g., formed on) the fourth layer 386 of the substrate package 290. The sixth metal layer 319 may be offset relative to the fourth metal layer 316 (and/or offset relative to the fifth metal layer 318). The sixth via structure 329 may be included in the fourth layer 386 and may be configured to couple the sixth metal layer 319 to the fourth metal layer 316. Although not depicted, the fifth via structure 328 may be included in the fourth layer 386 and may be configured to couple the sixth metal layer 319 to the fifth metal layer 318. The fifth layer 388 of the substrate package 290 may include the contact 204. The contact 204 may be positioned above (e.g., formed on) the sixth metal layer 319.

An example of a 3D antenna structure that includes multiple substructures is depicted and generally designated 350. For example, the 3D antenna structure 350 may include or correspond to the 3D antenna structure 140 of FIG. 1 or the 3D antenna structure 250 of FIG. 2. The 3D antenna structure 350 may be included within a substrate package, such as the substrate package 130 of FIG. 1, the substrate package 290 of FIG. 2, or the substrate package 390 of FIG. 3. The 3D antenna structure 350 may include multiple substructures, such as a first substructure 352, a second substructure 354, a third substructure 356, and a fourth substructure 358. The first substructure 352, the second substructure 354, the third substructure 356, and the fourth substructure 358 may include or correspond to the first substructure 144, the second substructure 142, the third substructure 146, and the fourth substructure 148 of FIG. 1, respectively. Although the 3D antenna structure 350 is illustrated as including four substructures, in other implementations, the 3D antenna structure 350 may include more than or fewer than four substructures. In some implementations, an antenna array may include multiple substructures and/or multiple 3D antenna structures. The more substructures and/or the more 3D antenna structures that are included in the antenna array, the better the directionality control and sensitivity of the array.

One or more of the substructures 352-358 may have the slanted-loop configuration. For example, one or more of the substructures 352-358 may include or correspond to the substructure 300. In some implementations, each of the substructures 352-358 has the slanted-loop configuration. In other implementations, at least one of the substructures 352-358 has the slanted-loop configuration and one or more of the other substructures may have another configuration, such as a slanted-plate configuration as described with reference to FIG. 2.

Each of the substructures 352-358 may be positioned about an axis 360 of the antenna structure 350. Each substructure may be positioned relative to the axis 360. For example, a first feature of the first substructure 352 may be positioned a first distance (D1) from the axis 360, and a second feature (corresponding to the first feature) of the second substructure 354 may be positioned a second distance (D2) from the axis 360. To illustrate, a first contact of the first substructure 352 may be positioned the first distance (D1) from the axis 260 and a second contact of the second substructure 354 may be positioned the second distance (D2) from the axis 260. In some implementations, each of substructures 352-358 may be positioned the same distance from the axis 360. For example, the first distance (D1) may be equal to the second distance (D2). In other implementations, one or more the substructures 352-358 may not be positioned at the same distance as the other substructures 352-358. For example, the first distance (D1) of the first substructure 352 may be different than the second distance (D2), and each of the second substructure 354, the third substructure 356, and the fourth substructure 358 may be the second distance (D2) from the axis 360.

A 3D antenna structure, such as the 3D antenna structure 350, that includes at least one substructure having the slanted-loop configuration (e.g., the substructure 300), may have beam-forming directionality in a range that is greater than 30°. Accordingly, the 3D antenna structure 350 may have a larger angle of coverage for mm-wave communication than conventional 2D planar antenna arrays which have a limited amount of beam-forming directionally (e.g., less than 30°).

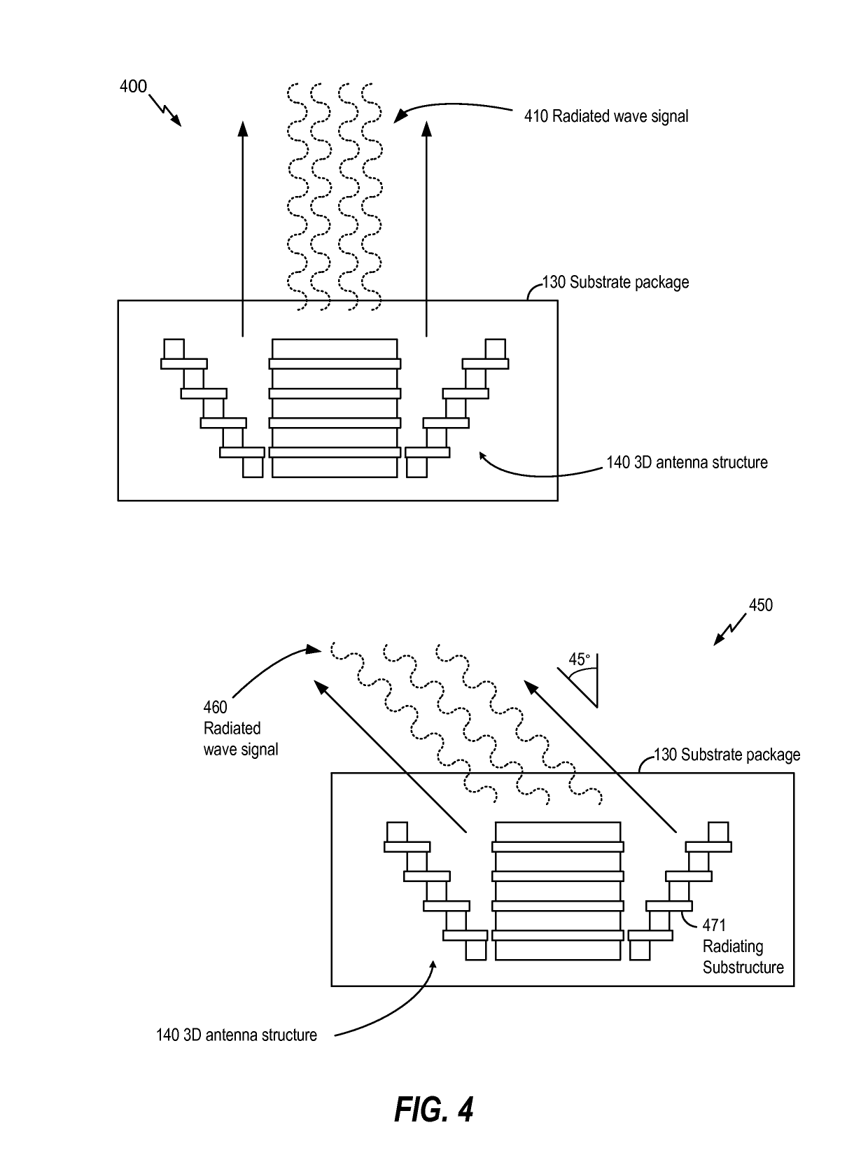

Referring to FIG. 4, examples of radiation patterns produced by a 3D antenna structure are depicted. As illustrated in FIG. 4, the 3D antenna structure is the 3D antenna structure 140 of FIG. 1. The 3D antenna structure 140 may include or correspond to the 3D antenna structure 250 of FIG. 2 or the 3D antenna structure 350 of FIG. 3. The 3D antenna structure 140 may be included in the substrate package 130. The substrate package 130 may include or correspond to the substrate package 290 of FIG. 2 or the substrate package 390 of FIG. 3.

A first example of a radiation pattern produced by the 3D antenna structure 140 is depicted and generally designated 400. In the first example 400, each substructure of the 3D antenna structure 140 receives a corresponding RF output signal to be transmitted by the substructure. Each RF output signal received at the 3D antenna structure 140 may have the same magnitude and the same phase. Accordingly, the radiated wave signal 410 of the 3D antenna structure 140 may be produced. The radiated wave signal 410 may be associated with a beam-forming directionality of 0°.

A second example of a radiation pattern produced by the 3D antenna structure 140 is depicted and generally designated 450. In the second example 450, each substructure of the 3D antenna structure 140 receives a corresponding RF output signal to be transmitted by the substructure. For example, a radiating substructure 471 may receive a particular RF output signal having a magnitude that is greater than RF output signals received by the other substructures of the 3D antenna structure 140. In some implementations, the RF output signals received by the other substructures may have a magnitude of zero. Accordingly, the radiated wave signal 460 of the 3D antenna structure 140 may be produced. The radiated wave signal 460 may be associated with a beam-forming directionality within a range of 45°. Although the radiated wave signal 460 is illustrated as having a beam-forming directionality within a range of 45°, in other implementations, the beam-forming directionality range of the radiated wave signal 460 may be greater than or less than 45°.

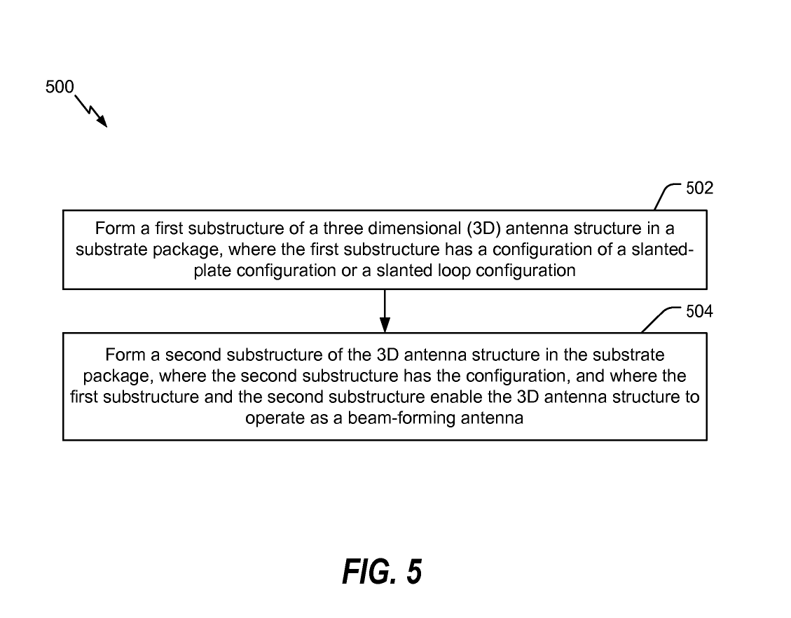

Referring to FIG. 5, a flow diagram of an illustrative embodiment of a method 500 of forming the 3D antenna structure is depicted. For example, the 3D antenna structure may include or correspond to the 3D antenna structure 140 of FIG. 1, the 3D antenna structure 250 of FIG. 2, or the 3D antenna structure 350 of FIG. 3.

The method 500 may include forming a first substructure of a three dimensional (3D) antenna structure in a substrate package, at 502. The first substructure may have a configuration that includes a slanted-plate configuration or a slanted-loop configuration. For example, the first substructure may include or correspond to the first substructure 144 of FIG. 1, the first substructure 252 of FIG. 2, or the first substructure 352 of FIG. 3. When the first substructure has the slanted-plate configuration, the first substructure may include or correspond to the substructure 200 of FIG. 2. When the first substructure has the slanted-loop configuration, the first substructure may include or correspond to the substructure 300 of FIG. 3. The substrate package may include or correspond to the substrate package 130 of FIG. 1, the substrate package 290 of FIG. 2, or the substrate package 390 of FIG. 3.

The method 500 may further include forming a second substructure of the 3D antenna structure in the substrate package, where the second substructure has the configuration, at 504. The first substructure and the second substructure may enable the 3D antenna structure to operate as a beam-forming antenna. For example, the second substructure may include or correspond to the second substructure 142 of FIG. 1, the first substructure 254 of FIG. 2, or the second substructure 354 of FIG. 3.

When the configuration is the slanted-plate configuration, forming the first substructure may include forming a first metal layer on a first layer of the substrate package and forming a second metal layer on a second layer of the substrate package. For example, the first metal layer may include or correspond to the first metal layer 210 formed on the first layer 280 of the substrate package 290 of FIG. 2. As another example, the second metal layer may include or correspond to the second metal layer 212 formed on the second layer 282 of the substrate package 290 of FIG. 2. The second metal layer may offset relative to the first metal layer. In some implementations, a via structure may be formed that couples the first metal layer to the second metal layer. For example, the via structure may include or correspond to the first via structure 230 of FIG. 2.

When the configuration is the slanted-loop configuration, forming the first substructure may include forming a first metal layer on a first layer of the substrate package and forming a first via structure and a second via structure coupled to the first metal layer. For example, the first metal layer may include or correspond to the first metal layer 310 of FIG. 3, and the first via structure and the second via structure may include or correspond to the first via structure 320 and the second via structure 322 of FIG. 3, respectively. The first layer of the substrate package may include or correspond to the first layer 380 of the substrate package 390 of FIG. 3. Additionally, a second metal layer and a third metal layer may be formed on a second layer of the substrate package. The second metal layer may be coupled to the first via structure, and the third metal layer is coupled to the second via structure. For example, the second metal layer may include or correspond to the third meal layer 314 of FIG. 3, and the third metal layer may include or correspond to the second metal layer 312 of FIG. 3. A fourth metal layer may be formed on a third layer of the substrate package. For example, the fourth metal layer may include or correspond to the sixth metal layer 319 formed on the fourth layer 386 of the substrate package 390 of FIG. 3. The first metal layer may be coupled to the fourth metal layer via a first path, such as the second path 308 of FIG. 3, that includes the second metal layer and the first via structure. Additionally or alternatively, the first metal layer may be coupled to the fourth metal layer via a second path, such as the first path 306 of FIG. 3, that includes the third metal layer and the second via structure.

In some implementations, the method 500 may include forming a third substructure of the 3D antenna structure in the substrate package. For example the third substructure may include or correspond to the third substructure 146 of FIG. 1, the third substructure 256 of FIG. 2, or the third substructure 356 of FIG. 3. The third substructure may have the same configuration as the first substructure or may have a different configuration than the first substructure. Additionally, the method 500 further includes forming a fourth substructure of the 3D antenna structure in the substrate package. For example, the fourth substructure may include or correspond to the fourth substructure 148 of FIG. 1, the fourth substructure 258 of FIG. 2, or the fourth substructure 358 of FIG. 3. The fourth substructure may have the same configuration as the first substructure or may have a different configuration than first substructure.

The method 500 may be used to form a 3D antenna structure having multiple substructures. The 3D antenna structure may have a beam-forming directionality range that is greater than 30°. Accordingly, the 3D antenna structure may be able to emit a focused beam (e.g., a radiated radio wave) over a larger angle of coverage than 2D planar antenna arrays.

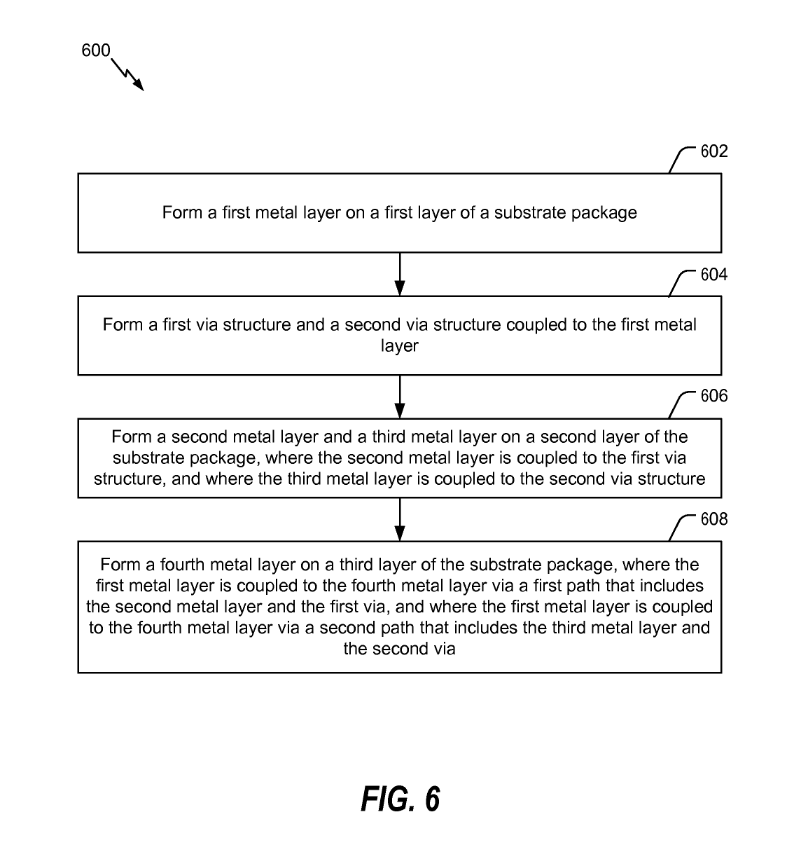

Referring to FIG. 6, a flow diagram of another illustrative embodiment of a method 600 of forming the 3D antenna structure is depicted. For example, the 3D antenna structure may include or correspond to the 3D antenna structure 140 of FIG. 1, the 3D antenna structure 250 of FIG. 2, or the 3D antenna structure 350 of FIG. 3. The 3D antenna structure may have a substructure having a slanted-loop configuration, such as the substructure 200 of FIG. 2.

The method 600 includes forming a first metal layer on a first layer of a substrate package, at 602. For example, the first metal layer may include or correspond to the first metal layer 310 of FIG. 3. The first metal layer may be formed on the first layer 380 of the substrate package 390 of FIG. 3. In some implementations, the first metal layer may be U-shaped.

The method 600 further includes forming a first via structure and a second via structure coupled to the first metal layer, at 604. The first via structure and the second via structure may include or correspond to the first via structure 320 and the second via structure 322 of FIG. 3, respectively.

The method 600 also includes forming a second metal layer and a third metal layer on a second layer of the substrate package, at 606. The second metal layer is coupled to the first via structure, and the third metal layer is coupled to the second via structure. For example, the second metal layer may include or correspond to the third meal layer 314 of FIG. 3, and the third metal layer may include or correspond to the second metal layer 312 of FIG. 3. The second layer of the substrate package may include or correspond to the second layer 382 of the substrate package 390 of FIG. 3. In some implementations, the second metal layer and/or the third metal layer is L-shaped.

The method 600 also includes forming a fourth metal layer on a third layer of the substrate package, at 608. The first metal layer is coupled to the fourth metal layer via a first path that includes the second metal layer and the first via structure, and the first metal layer is coupled to the fourth metal layer via a second path that includes the third metal layer and the second via structure. For example, the fourth metal layer may include or correspond to the sixth metal layer 319 formed on the fourth layer 386 of the substrate package 390 of FIG. 3. The second layer of the substrate package may be positioned between the first layer and the third layer of the substrate package. In some implementations, the fourth metal layer may be U-shaped. The first path may be distinct from the second path. The first path may include or correspond to the second path 308 of FIG. 3, and the second path may include or correspond to the first path 306 of FIG. 3.

The method 600 may be used to form a 3D antenna structure that includes at least one substructure having a slanted-loop configuration. The 3D antenna structure may have a beam-forming directionality range that is greater than 30°. Accordingly, the 3D antenna structure may be able to emit a focused beam (e.g., a radiated radio wave) over a larger angle of coverage than conventional 2D planar antenna arrays.

The method 500 of FIG. 5 and/or the method 600 of FIG. 6 may be implemented by a processing unit such as a central processing unit (CPU), a controller, a field-programmable gate array (FPGA) device, an application-specific integrated circuit (ASIC), a digital signal processor (DSP), another hardware device, firmware device, or any combination thereof. As an example, the method 500 of FIG. 5 and/or the method 600 of FIG. 6 can be performed by one or more processors that execute instructions to control fabrication equipment.

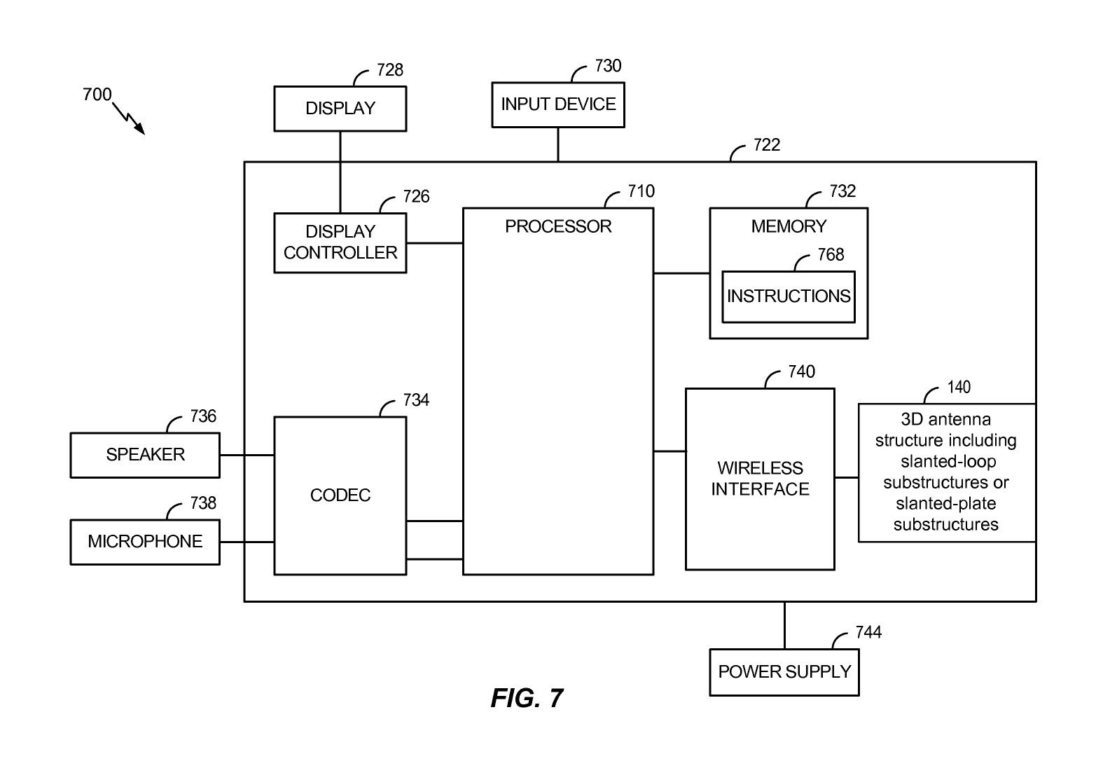

Referring to FIG. 7, a block diagram of a particular illustrative embodiment of an electronic device 700, such as a wireless communication device, is depicted. The electronic device 700 may include the 3D antenna structure 140 of FIG. 1. The 3D antenna structure 140 may include or correspond to the substructure 200, the 3D antenna structure 250 of FIG. 2, the substructure 300, the 3D antenna structure 350 of FIG. 3, a 3D antenna structure formed according to the method 500 of FIG. 5, a 3D antenna structure formed according to the method 600 of FIG. 6, or a combination thereof.

The electronic device 700 includes a processor 710, such as a digital signal processor (DSP), coupled to a memory 732. The processor 710 may be configured to generate the one or more data streams 160 of FIG. 1. In some implementations, the processor 710 may include the controller 120 of FIG. 1. The memory 732 includes instructions 768 (e.g., executable instructions) such as computer-readable instructions or processor-readable instructions. The instructions 768 may include one or more instructions that are executable by a computer, such as the processor 710.

FIG. 7 also shows a display controller 726 that is coupled to the processor 710 and to a display 728. A coder/decoder (CODEC) 734 can also be coupled to the processor 710. A speaker 736 and a microphone 738 can be coupled to the CODEC 734.

FIG. 7 also indicates that a wireless interface 740, such as a wireless controller, can be coupled to the processor 710 and to the 3D antenna structure 140. The wireless interface 740 may include or correspond to the wireless interface circuitry 110 of FIG. 1. For example, the wireless interface 740 may include the transmitter unit 122 that is configured to provide one or more RF output signals to the 3D antenna structure 140. The 3D antenna structure 140 may include one or more substructures that include a slanted-plate configuration, such as the substructure 200 of FIG. 2, and/or one or more substructures that include a slanted-loop configuration, such as the substructure 300 of FIG. 3. For example, the 3D antenna structure 140 may include multiple substructures that have the slanted-plate configuration and/or multiple substructures that have the slanted-loop configuration.

In some implementations, the processor 710, the display controller 726, the memory 732, the CODEC 734, and the wireless interface 740, the 3D antenna structure 140, or a combination thereof, may be included in a system-in-package or system-on-chip device 722. For example, the system-on-chip device 722 may include or correspond to the substrate package 130 of FIG. 1, the substrate package 290 of FIG. 2, or the substrate package 390 of FIG. 3. An input device 730 and a power supply 744 may be coupled to the system-on-chip device 722. Moreover, in some implementations, as illustrated in FIG. 7, the display 728, the input device 730, the speaker 736, the microphone 738, and the power supply 744 are external to the system-on-chip device 722. However, each of the display 728, the input device 730, the speaker 736, the microphone 738, and the power supply 744 can be coupled to a component of the system-on-chip device 722, such as an interface or a controller.

One or more of the disclosed embodiments may be implemented in a system or an apparatus, such as the electronic device 700, that may include a communications device, a fixed location data unit, a mobile location data unit, a mobile phone, a cellular phone, a satellite phone, a computer, a tablet, a portable computer, or a desktop computer. Alternatively or additionally, the electronic device 700 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a vehicle, a satellite, any other device that includes or is coupled to an antenna, or a combination thereof. As another illustrative, non-limiting example, the system or the apparatus may include remote units, such as hand-held personal communication systems (PCS) units, portable data units such as global positioning system (GPS) enabled devices, meter reading equipment, or any other device that includes or is coupled to an antenna, or any combination thereof.

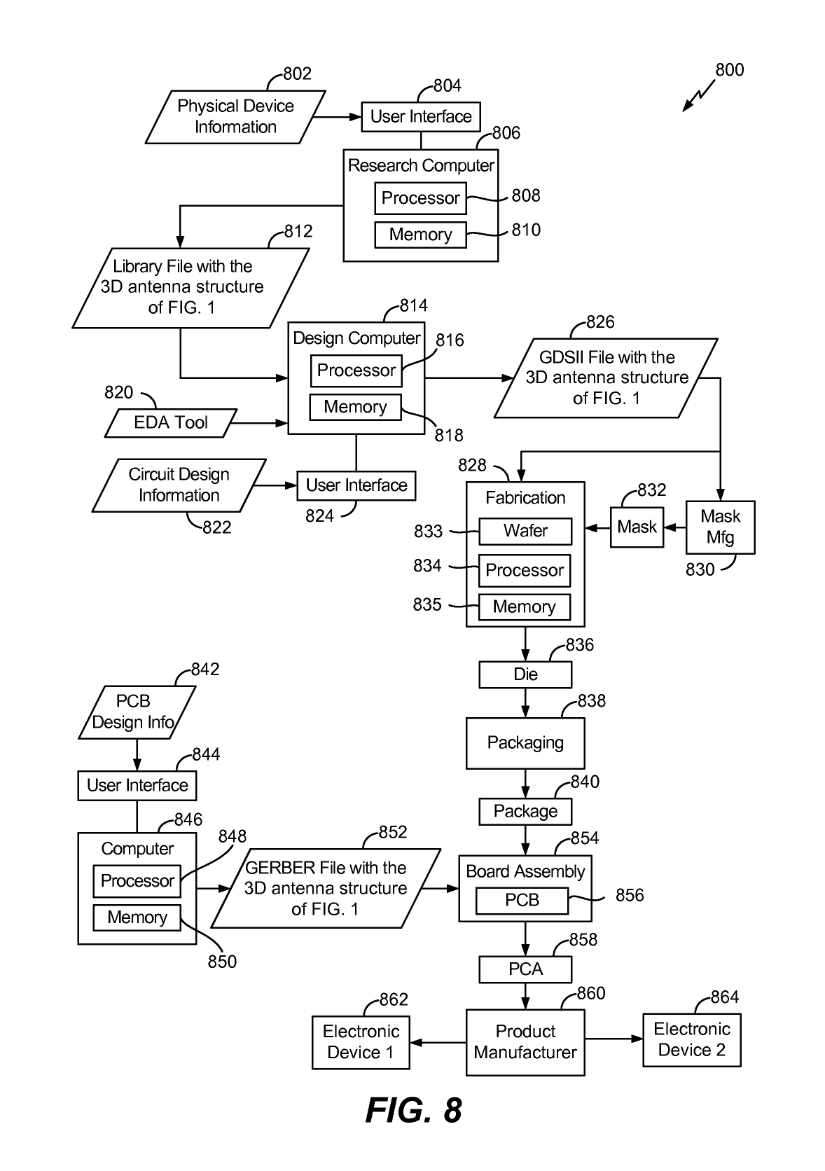

The foregoing disclosed devices and functionalities may be designed and configured into computer files (e.g. RTL, GDSII, GERBER, etc.) stored on computer-readable media. Some or all such files may be provided to fabrication handlers who fabricate devices based on such files. Resulting products include semiconductor wafers that are then cut into semiconductor die and packaged into a semiconductor chip. The chips are then employed in devices described above. FIG. 8 depicts a particular illustrative embodiment of an electronic device manufacturing process 800.

Physical device information 802 is received at the manufacturing process 800, such as at a research computer 806. The physical device information 802 may include design information representing at least one physical property of a 3D antenna structure and/or a substructure of the 3D antenna structure, such as the 3D antenna structure 140 of FIG. 1, the substructure 200, the 3D antenna structure 250 of FIG. 2, the substructure 300, the 3D antenna structure 350 of FIG. 3, a 3D antenna structure formed according to the method 500 of FIG. 5, a 3D antenna structure formed according to the method 600 of FIG. 6, or a combination thereof. For example, the physical device information 802 may include physical parameters, material characteristics, and structure information that is entered via a user interface 804 coupled to the research computer 806. The research computer 806 includes a processor 808, such as one or more processing cores, coupled to a computer-readable medium (e.g., a non-transitory computer-readable medium), such as a memory 810. The memory 810 may store computer-readable instructions that are executable to cause the processor 808 to transform the physical device information 802 to comply with a file format and to generate a library file 812.

In some implementations, the library file 812 includes at least one data file including the transformed design information. For example, the library file 812 may include a library of devices including a device that includes the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof, that is provided for use with an electronic design automation (EDA) tool 820.

The library file 812 may be used in conjunction with the EDA tool 820 at a design computer 814 including a processor 816, such as one or more processing cores, coupled to a memory 818. The EDA tool 820 may be stored as processor executable instructions at the memory 818 to enable a user of the design computer 814 to design a circuit including the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof. For example, a user of the design computer 814 may enter circuit design information 822 via a user interface 824 coupled to the design computer 814. The circuit design information 822 may include design information representing at least one physical property of the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof. To illustrate, the circuit design property may include identification of particular circuits and relationships to other elements in a circuit design, positioning information, feature size information, interconnection information, or other information representing a physical property of a semiconductor device.

The design computer 814 may be configured to transform the design information, including the circuit design information 822, to comply with a file format. To illustrate, the file format may include a database binary file format representing planar geometric shapes, text labels, and other information about a circuit layout in a hierarchical format, such as a Graphic Data System (GDSII) file format. The design computer 814 may be configured to generate a data file including the transformed design information, such as a GDSII file 826 that includes information describing the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof, in addition to other circuits or information. To illustrate, the data file may include information corresponding to a system-on-chip (SOC) that includes the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof, and that also includes additional electronic circuits and components within the SOC. The SOC may include or correspond to the substrate package 130 of FIG. 1, the substrate package 290 of FIG. 2, or the substrate package 390 of FIG. 3.

The GDSII file 826 may be received at a fabrication process 828 to manufacture the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof, according to transformed information in the GDSII file 826. For example, a device manufacture process may include providing the GDSII file 826 to a mask manufacturer 830 to create one or more masks, such as masks to be used with photolithography processing, illustrated as a representative mask 832. The mask 832 may be used during the fabrication process to generate one or more wafers 833, which may be tested and separated into dies, such as a representative die 836. The die 836 includes a circuit including a device that includes the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof.

For example, the fabrication process 828 may include a processor 834 and a memory 835 to initiate and/or control the fabrication process 828. The memory 835 may include executable instructions such as computer-readable instructions or processor-readable instructions. The executable instructions may include one or more instructions that are executable by a computer such as the processor 834.

The fabrication process 828 may be implemented by a fabrication system that is fully automated or partially automated. For example, the fabrication process 828 may be automated according to a schedule. The fabrication system may include fabrication equipment (e.g., processing tools) to perform one or more operations to form a 3D antenna structure. For example, the fabrication equipment may be configured to deposit one or more materials, etch one or more materials, etch one or more dielectric materials, etch one or more etch stop layers, perform a chemical mechanical planarization process, etc.

The fabrication system (e.g., an automated system that performs the fabrication process 828) may have a distributed architecture (e.g., a hierarchy). For example, the fabrication system may include one or more processors, such as the processor 834, one or more memories, such as the memory 835, and/or controllers that are distributed according to the distributed architecture. The distributed architecture may include a high-level processor that controls or initiates operations of one or more low-level systems. For example, a high-level portion of the fabrication process 828 may include one or more processors, such as the processor 834, and the low-level systems may each include or may be controlled by one or more corresponding controllers. A particular controller of a particular low-level system may receive one or more instructions (e.g., commands) from a particular high-level system, may issue sub-commands to subordinate modules or process tools, and may communicate status data back to the particular high-level. Each of the one or more low-level systems may be associated with one or more corresponding pieces of fabrication equipment (e.g., processing tools). In some implementations, the fabrication system may include multiple processors that are distributed in the fabrication system. For example, a controller of a low-level system component may include a processor, such as the processor 834.

Alternatively, the processor 834 may be a part of a high-level system, subsystem, or component of the fabrication system. In another implementation, the processor 834 includes distributed processing at various levels and components of a fabrication system.

Thus, the processor 834 may include processor-executable instructions that, when executed by the processor 834, cause the processor 834 to initiate or control formation of the 3D antenna structure. For example, the executable instructions included in the memory 835 may enable the processor 834 to initiate formation of the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof. In some implementations, the memory 835 is a non-transient computer-readable medium storing computer-executable instructions that are executable by the processor 834 to cause the processor 834 to initiate formation of 3D antenna structure in accordance with at least a portion of the method 500 of FIG. 5, at least a portion of the method 600 of FIG. 6, or any combination thereof. For example, the computer executable instructions may be executable to cause the processor 834 to initiate formation of the 3D antenna structure 140 of FIG. 1, the substructure 200, the 3D antenna structure 250 of FIG. 2, the substructure 300, or the 3D antenna structure 350 of FIG. 3.

As an illustrative example, the processor 834 may initiate or control forming a first substructure of a three dimensional (3D) antenna structure in a substrate package. The first substructure may have a configuration that includes a slanted-plate configuration or a slanted-loop configuration. The processor 834 may further initiate or control forming a second substructure of the 3D antenna structure in the substrate package, where the second substructure has the configuration. The first substructure and the second substructure may enable the 3D antenna structure to operate as a beam-forming antenna.

As another illustrative example, the processor 834 may initiate or control forming a first metal layer on a first layer of a substrate package and forming a first via structure and a second via structure coupled to the first metal layer. The processor 834 may further initiate or control forming a second metal layer and a third metal layer on a second layer of the substrate package. The second metal layer is coupled to the first via structure, and the third metal layer is coupled to the second via structure. The processor 834 may also initiate or control forming a fourth metal layer on a third layer of the substrate package. The first metal layer is coupled to the fourth metal layer via a first path that includes the second metal layer and the first via structure, and the first metal layer is coupled to the fourth metal layer via a second path that includes the third metal layer and the second via structure.

The die 836 may be provided to a packaging process 838 where the die 836 is incorporated into a representative package 840. For example, the package 840 may include the single die 836 or multiple dies, such as a system-in-package (SiP) arrangement. For example, the SiP may include or correspond to a system-in-package or the system-on-chip device 722 of FIG. 7. The package 840 may be configured to conform to one or more standards or specifications, such as Joint Electron Device Engineering Council (JEDEC) standards.

Information regarding the package 840 may be distributed to various product designers, such as via a component library stored at a computer 846. The computer 846 may include a processor 848, such as one or more processing cores, coupled to a memory 850. A printed circuit board (PCB) tool may be stored as processor executable instructions at the memory 850 to process PCB design information 842 received from a user of the computer 846 via a user interface 844. The PCB design information 842 may include physical positioning information of a packaged semiconductor device on a circuit board, the packaged semiconductor device including the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof.

The computer 846 may be configured to transform the PCB design information 842 to generate a data file, such as a GERBER file 852 with data that includes physical positioning information of a packaged semiconductor device on a circuit board, as well as layout of electrical connections such as traces (e.g., metal lines) and vias (e.g., via structures), where the packaged semiconductor device corresponds to the package 840 including the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof. In other implementations, the data file generated by the transformed PCB design information may have a format other than a GERBER format.

The GERBER file 852 may be received at a board assembly process 854 and used to create PCBs, such as a representative PCB 856, manufactured in accordance with the design information stored within the GERBER file 852. For example, the GERBER file 852 may be uploaded to one or more machines to perform various steps of a PCB production process. The PCB 856 may be populated with electronic components including the package 840 to form a representative printed circuit assembly (PCA) 858.

The PCA 858 may be received at a product manufacture process 860 and integrated into one or more electronic devices, such as a first representative electronic device 862 and a second representative electronic device 864. For example, the first representative electronic device 862, the second representative electronic device 864, or both, may include or correspond to the wireless communication device 700 of FIG. 7. As an illustrative, non-limiting example, the first representative electronic device 862, the second representative electronic device 864, or both, may include a communications device, a fixed location data unit, a mobile location data unit, a mobile phone, a cellular phone, a satellite phone, a computer, a tablet, a portable computer, or a desktop computer. Alternatively or additionally, the first representative electronic device 862, the second representative electronic device 864, or both, may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a vehicle, a satellite, any other device that generates or uses data that is wirelessly communicated, or a combination thereof, into which the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof, is integrated. As another illustrative, non-limiting example, one or more of the electronic devices 862 and 864 may include remote units, such as mobile phones, hand-held personal communication systems (PCS) units, portable data units such as personal data assistants, global positioning system (GPS) enabled devices, navigation devices, fixed location data units such as meter reading equipment, or any other device that generates or uses data that is wirelessly communicated, or any combination thereof. Although FIG. 8 illustrates remote units according to teachings of the disclosure, the disclosure is not limited to these illustrated units. Embodiments of the disclosure may be suitably employed in any device which includes active integrated circuitry including memory and on-chip circuitry.

A device that includes the 3D antenna structure 140 of FIG. 1, the substructure 200, the 3D antenna structure 250 of FIG. 2, the substructure 300, the 3D antenna structure 350 of FIG. 3, a 3D antenna structure formed using the method 500 of FIG. 5, a 3D antenna structure formed using the method 600 of FIG. 6, or a combination thereof, may be fabricated, processed, and incorporated into an electronic device, as described in the illustrative process 800. One or more aspects of the embodiments disclosed with respect to FIGS. 1-8 may be included at various processing stages, such as within the library file 812, the GDSII file 826 (e.g., a file having a GDSII format), and the GERBER file 852 (e.g., a file having a GERBER format), as well as stored at the memory 810 of the research computer 806, the memory 818 of the design computer 814, the memory 850 of the computer 846, the memory of one or more other computers or processors (not shown) used at the various stages, such as at the board assembly process 854, and also incorporated into one or more other physical embodiments such as the mask 832, the die 836, the package 840, the PCA 858, other products such as prototype circuits or devices (not shown), or any combination thereof. Although various representative stages of production from a physical device design to a final product are depicted, in other embodiments fewer stages may be used or additional stages may be included. Similarly, the process 800 may be performed by a single entity or by one or more entities performing various stages of the process 800.

Although one or more of FIGS. 1-8 may illustrate systems, apparatuses, and/or methods according to the teachings of the disclosure, the disclosure is not limited to these illustrated systems, apparatuses, and/or methods. Embodiments of the disclosure may be suitably employed in any device that includes integrated circuitry including memory, a processor, and on-chip circuitry.

Although one or more of FIGS. 1-8 may illustrate systems, apparatuses, and/or methods according to the teachings of the disclosure, the disclosure is not limited to these illustrated systems, apparatuses, and/or methods. One or more functions or components of any of FIGS. 1-8 as illustrated or described herein may be combined with one or more other portions of another of FIGS. 1-8. Accordingly, no single embodiment described herein should be construed as limiting and embodiments of the disclosure may be suitably combined without departing from the teachings of the disclosure.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. For example, a storage medium may be coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a substrate package; and
a three dimensional (3D) antenna structure formed in the substrate package, the 3D antenna structure including multiple substructures, wherein at least one of the multiple substructures has a slanted-plate configuration or a slanted-loop configuration.

2. The apparatus of claim 1, wherein the substrate package is a multi-layered substrate package.

3. The apparatus of claim 1, wherein, for each of the multiple substructures having the slanted-plate configuration, each of the multiple substructures having the slanted-plate configuration comprises:
a first metal layer formed on a first layer of the substrate package;
a second metal layer formed on a second layer of the substrate package, wherein the second metal layer is offset relative to the first metal layer; and
a via structure that couples the first metal layer to the second metal layer.

4. The apparatus of claim 1, wherein, for each of the multiple substructures having the slanted-loop configuration, each of the multiple substructures having the slanted-loop configuration comprises:
a first metal layer formed on a first layer of the substrate package;
a second metal layer formed on a second layer of the substrate package;
a first via structure that couples the first metal layer to the second metal layer;
a third metal layer formed on the second layer of the substrate package;
a second via structure that couples the first metal layer to the third metal layer; and
a fourth metal layer formed on a third layer of the substrate package, wherein the first metal layer is coupled to the fourth metal layer via a first path that includes the second metal layer and the first via structure, and wherein the first metal layer is coupled to the fourth metal layer via a second path that includes the third metal layer and the second via structure.

5. The apparatus of claim 1, wherein the multiple substructures include two or more distinct substructures.

6. The apparatus of claim 1, wherein the 3D antenna structure is configured to transmit a millimeter (mm) wave signal.

7. The apparatus of claim 1, wherein the 3D antenna structure is configured to operate within a range of 40 gigahertz (GHz) to 100 GHz.

8. The apparatus of claim 1, wherein the 3D antenna structure has a directionality range of greater than 30 degrees.

9. The apparatus of claim 1, further comprising an antenna array formed in the substrate package, wherein the antenna array includes the 3D antenna structure.

10. The apparatus of claim 1, further comprising wireless interface circuitry coupled to the 3D antenna structure, wherein the wireless interface circuitry is configured to independently control signals provided to each of the multiple substructures.

11. A method of forming an antenna, the method comprising:
forming a first substructure of a three dimensional (3D) antenna structure in a substrate package, wherein the first substructure has a configuration of a slanted-plate configuration or a slanted-loop configuration; and
forming a second substructure of the 3D antenna structure in the substrate package, wherein the second substructure has the same configuration as the first substructure, and wherein the first substructure and the second substructure enable the 3D antenna structure to operate as a beam-forming antenna.

12. The method of claim 11, further comprising forming a third substructure of the 3D antenna structure in the substrate package, wherein the third substructure has the same configuration as the first substructure.

13. The method of claim 12, further comprising forming a fourth substructure of the 3D antenna structure in the substrate package, wherein the fourth substructure has the same configuration as the first substructure.

14. The method of claim 11, wherein, when the configuration is the slanted-loop configuration, forming the first substructure comprises:
forming a first metal layer on a first layer of the substrate package;
forming a first via structure and a second via structure coupled to the first metal layer;
forming a second metal layer and a third metal layer on a second layer of the substrate package, where the second metal layer is coupled to the first via structure, and wherein the third metal layer is coupled to the second via structure; and
forming a fourth metal layer on a third layer of the substrate package, wherein the first metal layer is coupled to the fourth metal layer via a first path that includes the second metal layer and the first via structure, and wherein the first metal layer is coupled to the fourth metal layer via a second path that includes the third metal layer and the second via structure.

15. The method of claim 11, wherein, when the configuration is the slanted-plate configuration, forming the first substructure comprises:
forming a first metal layer formed on a first layer of the substrate package;
forming a second metal layer formed on a second layer of the substrate package, wherein the second metal layer is offset relative to the first metal layer; and
forming a via structure that couples the first metal layer to the second metal layer.

16. An apparatus comprising:
a substrate package; and
a three dimensional (3D) antenna structure formed in the substrate package, the 3D antenna structure including a substructure, the substructure comprising:
a first metal layer formed on a first layer of the substrate package;
a second metal layer formed on a second layer of the substrate package;
a first via structure that couples the first metal layer to the second metal layer;
a third metal layer formed on the second layer of the substrate package;
a second via structure that couples the first metal layer to the third metal layer; and
a fourth metal layer formed on a third layer of the substrate package, wherein the first metal layer is coupled to the fourth metal layer via a first path that includes the second metal layer and the first via structure, and wherein the first metal layer is coupled to the fourth metal layer via a second path that includes the third metal layer and the second via structure.

17. The apparatus of claim 16, wherein the substrate package is a multi-layered substrate package.

18. The apparatus of claim 16, wherein the substructure has a slanted-loop configuration.

19. The apparatus of claim 16, wherein the 3D antenna structure includes multiple substructures, and wherein each substructure of the multiple substructures has a slanted-loop configuration.

20. The apparatus of claim 16, wherein the substructure is configured to enable the 3D antenna structure to operate as a beam-forming antenna.

21. The apparatus of claim 16, wherein the first metal layer is coupled to a first contact, and wherein the fourth metal layer is coupled to a second contact.

22. The apparatus of claim 16, wherein the substructure further comprises:
a fifth metal layer formed on a fourth layer of the substrate package;
a sixth metal layer formed on the fourth layer of the substrate package;
a third via structure that couples the fourth metal layer to the fifth metal layer; and
a fourth via structure that couples the fourth metal layer to the fifth metal layer.

23. The apparatus of claim 22, wherein the fourth layer of the substrate is positioned between the second layer and the third layer, and wherein the substructure further comprises:
a fifth via structure that couples the second metal layer to the fifth metal layer; and
a sixth via structure that couples the third metal layer to the sixth metal layer.

24. The apparatus of claim 22, wherein the fifth metal layer is L-shaped, and wherein the sixth metal layer is L-shaped.

25. The apparatus of claim 16, further comprising an antenna array, wherein the antenna array includes the 3D antenna structure.

26. A method of forming a three dimensional (3D) antenna structure, the method comprising:
forming a first metal layer on a first layer of a substrate package;
forming a first via structure and a second via structure coupled to the first metal layer;
forming a second metal layer and a third metal layer on a second layer of the substrate package, where the second metal layer is coupled to the first via structure, and wherein the third metal layer is coupled to the second via structure; and
forming a fourth metal layer on a third layer of the substrate package, wherein the first metal layer is coupled to the fourth metal layer via a first path that includes the second metal layer and the first via structure, and wherein the first metal layer is coupled to the fourth metal layer via a second path that includes the third metal layer and the second via structure.

27. The method of claim 26, wherein the first path is distinct from the second path.

28. The method of claim 26, wherein the second layer of the substrate is positioned between the first layer and the third layer.

29. The method of claim 26, wherein the first metal layer is U-shaped, and wherein the fourth metal layer is U-shaped.

30. The method of claim 26, wherein the second metal layer is L-shaped, and wherein the third metal layer is L-shaped.
